(19) United States
(12) Patent Application Publication
(10) Pub. No.: US 2022/0003501 A1
(43) Pub. Date: Jan. 6, 2022

(54) HEAT EXCHANGER

(71) Applicant: Massachusetts Institute of Technology, Cambridge, MA (US)

(72) Inventor: Asegun Henry, Boston, MA (US)

(73) Assignee: Massachusetts Institute of Technology, Cambridge, MA (US)

(21) Appl. No.: 17/364,811

(22) Filed: Jun. 30, 2021

Related U.S. Application Data
(60) Provisional application No. 63/047,223, filed on Jul. 1, 2020.

(51) Int. Cl. F28C 1/02; F28C 1/00; F28F 25/12

(52) U.S. Cl. CPC F28C 1/02; F28F 25/06; F28F 25/12; F28C 1/003

(57) ABSTRACT

A heat exchanger may include a first container having a gas inlet, a liquid inlet, a gas outlet, and a liquid outlet. The gas inlet may flow a gas at a first temperature into the container while the liquid inlet introduces droplets of a liquid into the container at a second temperature. In the container, the liquid droplets may fall under the force of gravity while the gas flows through the container in a direction that is different from a direction of the spray of the liquid through the container. Accordingly, the liquid and the gas may come into direct contact within the first container and exchange heat. After the liquid and gas exchange heat, the liquid may leave the container through the liquid outlet and the gas may leave the container through the gas outlet.

### CROSS-REFERENCE TO RELATED APPLICATIONS

This Application claims the benefit under 35 U.S.C. § 119(e) of U.S. Provisional Application Ser. No. 63/047,223, filed on Jul. 1, 2020, which is incorporated herein in its entirety.

### FIELD

This disclosure relates to heat exchangers, such as those that facilitate an exchange of heat between a liquid and a gas, or a gas and a gas.

### BACKGROUND

In power plants, heat exchangers are known to be used to transfer energy between two flows of fluid during various portions of a thermodynamic cycle. For example, conventional heat exchangers may exchange heat between a waste gas to preheat an inflow of a gas into the system. To facilitate heat exchange, some conventional heat exchangers function by allowing two media (e.g., gasses and/or liquids) to exchange heat across a solid wall. The solid wall may act as an intermediate heat transfer surface located between the two media.

### BRIEF SUMMARY

In some embodiments, a heat exchanger includes a first container; a first gas inlet configured to supply a first gas at a first temperature to the first container; a first liquid inlet configured to introduce droplets of a first liquid at a second temperature into the first container, wherein the first gas and the first liquid exchange heat in the first container through direct contact; a first gas outlet configured such that the first gas exits the container through the first gas outlet after exchanging heat with the first liquid; and a first liquid outlet configured such that the first liquid exits the container through the first liquid outlet after exchanging heat with the first gas.

In some embodiments, a method of exchanging heat between one or more liquids and one or more gasses includes flowing a first gas into a first container at a first temperature; introducing droplets of a first liquid into the first container at a second temperature; flowing the first gas and the droplets through an internal volume of the container; exchanging heat between the first gas and the first liquid through direct contact between the first gas and the first liquid; and flowing the first gas and the first liquid out of the first container after exchanging heat.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a schematic view of a heat exchanger according to a first illustrative embodiment;

FIG. 2 is a schematic view of a heat exchanger according to a second illustrative embodiment; and

FIG. 3 is a schematic view of a heat exchanger according to a third illustrative embodiment;

FIG. 4 is a flowchart showing a method of exchanging heat between a liquid and a gas.

In the drawings, preferred embodiments of the disclosure are illustrated by way of example, it being expressly understood that the description and drawings are only for the purpose of illustration and preferred designs and are not intended as a definition of the limits of the disclosure.

### DETAILED DESCRIPTION

Heat exchangers may serve to facilitate an exchange of thermal energy (e.g., heat) between two or more media (e.g., fluids) at various points during a thermodynamic cycle. Typically, some conventional heat exchangers function by allowing the two or more media to exchange heat across a solid wall. The solid wall may act as an intermediate heat transfer surface located between the two media. However, transferring heat between media across a solid wall may result in inefficient and expensive heat transfer, since media such as gasses may tend to have low heat transfer coefficients, owing to their low density and therefore low thermal conductivity. The low thermal conductivity of certain media may require that a conventional heat exchanger include a large, solid surface area (e.g., via fins and/or extended surfaces) to reduce the net resistance to heat transfer, which may be expensive to construct and maintain.

In view of the above, the Inventor has recognized that the inclusion of a solid wall between two flows of media may add to the cost of a heat exchanger and reduce the overall efficiency of the heat transfer within a heat exchanger. Accordingly, the Inventor has recognized the advantages of a heat exchanger where a flow of gas at one temperature flowing through a volume is able to transfer heat directly to a flow of liquid moving through the volume in a different direction without a solid intermediate barrier between the flows of media (e.g., via direct contact between the media). Thus, the cost of the heat exchanger may be reduced, and the efficiency of heat transfer may be improved. Specifically, heat losses and costs associated with the intermediate barrier may be eliminated. Thus, a heat exchanger as disclosed herein may be more cost effective and more efficient than a conventional heat exchanger.

Embodiments disclosed herein relate to a heat exchanger capable of exchanging heat between two media via direct contact between the media. Particularly, in some embodiments, a heat exchanger may bring a first media, such as a gas, into contact with a second media, such as a liquid. For example, in some embodiments, the heat exchanger may include a chamber where the liquid and the gas may come into contact to facilitate heat exchange between the liquid and the gas.

In some embodiments, a heat exchanger employs a method of exchanging heat between one or more liquids and one or more gasses. The method may include first flowing a first gas, such as air, N₂, O₂, or any other suitable gas, into a first container at a first temperature. Then, a first liquid, such as water, a molten salt, or any other suitable liquid, may be introduced into the first container at a second temperature in the form of a plurality of droplets. In some embodiments, once the first liquid and the first gas are introduced into the first container, the first gas may flow along a first flow path that is at least partially different a second flow path of the liquid. For example, in some instances, the droplets of the first liquid may be introduced into the interior of the container such that the droplets move vertically downward in the direction of gravity, while the first gas may move at least partially in an opposite direction to the first liquid such that the gas moves vertically upward through at least a portion the container. However, embodiments in which the gas does not move vertically upwards and/or the liquid moves vertically downward are also contemplated. Accordingly, it should be understood that the various embodiments disclosed herein include any arrangement in which the first and second flow paths at least partially overlap as the gas and liquid separately flow into and out of the container. Further, as the first gas and liquid flow through the container, the first gas and the first liquid may come into direct contact with one another within an internal volume of the container such that they exchange heat between one another.

In some embodiments, a heat exchanger includes a first container, a first gas inlet, a first liquid inlet, a first gas outlet, and a first liquid outlet. The first gas inlet may be configured to supply a first gas at a first temperature to the first container, and the first liquid inlet may be configured to form droplets of a first liquid at a second temperature that flow into the interior of the first container. The liquid droplets may travel downwards through the first container due to gravity, while the first gas travels upwards, or in another appropriate direction, through the container. As the first liquid moves downwards and the first gas travels through the container, the first liquid and the first gas may come into direct contact and exchange heat. After the first liquid and the first gas exchange heat, the first gas may then flow out from the first container through a first gas outlet and the first liquid may flow out from the first container through a first liquid outlet.

In some embodiments, it may be desirable to exchange heat between multiple flows of fluid and/or to use multiple fluids that operate at different temperatures for heat exchange purposes. Thus, in some embodiments, a system may include multiple interconnected heat exchangers where either multiple flows of gas at different temperatures are exposed to the same liquid sequentially and/or a flow of gas may be exposed to multiple different liquids at different temperatures. Examples of possible systems are detailed below.

In one embodiment, a heat exchanger system may include a second container in addition to the first container (e.g., as described herein). The second container may include a second gas inlet and a second liquid inlet. The first liquid outlet of the first container may connect to the second liquid inlet so as to flow the first liquid from the first container into the second container. In turn, the second gas inlet may supply a second gas at a third temperature to the second container. The first liquid and the second gas may then exchange heat in the second container through direct contact, as with the first container. After exchanging heat with the first liquid, the second gas may then leave the second container through a second gas outlet. After exchanging heat with the second gas, the first liquid may leave the second container through a second liquid outlet. The first liquid may then flow from the second liquid outlet towards the first liquid inlet of the first container and/or an inlet of another heat exchanger.

In another embodiment, a heat exchanger system may include a second container with a second gas inlet and a second liquid inlet, wherein the first gas outlet of the first container flows the first gas into the second gas inlet of the second container. The second liquid inlet may be configured to form droplets of a second liquid, which may travel downwards through the second container due to gravity, at a third temperature. The second liquid may exchange heat with the first gas through direct contact in the second container. After the first gas and the second liquid exchange heat in the second container, the first gas may leave the second container through a second gas outlet, while the second liquid may leave the second container through a second liquid outlet.

To avoid contaminating a flow of gas through a heat exchanger, it may be desirable to use liquids within the disclosed heat exchangers that have relatively low vapor pressures in the desired range of operating temperatures. For example, in one embodiment, a vapor pressure of a liquid used in a desired range of operating temperatures (e.g., between the first and second temperatures of a heat exchanger) may be relatively low to avoid introducing the vaporized liquid into the counter flow of gas. Alternatively, in some embodiments, some fraction of the flow of liquid through a heat exchanger may vaporize and become incorporated with the flow of gas through the heat exchanger. In such an embodiment, the material may be separated out of the flow of gas once the flow of gas cools to a sufficiently low temperature such that the vaporized liquid returns to the liquid state. The liquid may then be recovered for subsequent use in the heat exchanger depending on the application and the cost of the liquid used for the heat exchange process. Such a process may be implemented using any appropriate vapor capture system as the disclosure is not limited to any particular method for condensing and capturing the vapor.

A liquid may have any suitable vapor pressure or combination of vapor pressures depending on the application, as the disclosure is not limited in this fashion.

As will be appreciated by one of skill in the art, if the droplets of the first liquid are non-uniform, some droplets may become entrained in the flow of gas. Specifically, smaller droplets may experience a net upward force as they attempt to fall which may cause them to become entrained in the gas flow. To prevent the entrainment of liquid droplets in a flow of gas through a heat exchanger, the gas flow rate may be reduced to a sufficiently low velocity such that a predetermined minimum droplet size does not become entrained in the gas flow. Alternatively or in addition, entrained liquid droplets may be otherwise captured or reclaimed.

The droplets of the heat exchange liquid introduced into the interior volume of a container of a heat exchanger may have any appropriate size and/or size distribution depending on the desired application, as the disclosure is not limited in this fashion.

Depending on the desired application as well as the gases and heat transfer liquids used, a heat exchanger, or series of heat exchangers, may operate over any appropriate temperature range including, but not limited to, temperatures greater than or equal to 0° C., 25° C., 100° C., 250° C., 500° C., and/or any other appropriate temperature range. The operating temperatures may also be less than or equal to 1000° C., 500° C., 250° C., 100° C., and/or any other appropriate temperature range. Combinations of the above ranges are contemplated including, an operating temperature range for one or more heat exchangers that is between or equal to 0° C. and 1000° C. Of course, ranges of operating temperatures both greater than and less than those noted above are also contemplated as the disclosure is not limited in this fashion.

The flow rates of a liquid and/or a gas through a heat exchanger may be dependent on the size, types of liquids and gases being used, amount of heat being exchanged, and/or other appropriate operating parameters. Of course, any suitable flow rates of a gas and/or liquid through a heat exchanger may be employed depending on the application, as the disclosure is not so limited in this regard.

It should be understood that any appropriate combination of gases and/or liquids may be used in the various embodiments disclosed herein depending on the desired application and operating temperatures. For example, appropriate liquids may include, but are not limited to: heat transfer oil; molten salts such as NaNO₃—KNO₃, oxidation resistant molten salts such as CaCl₂—NaCl, other appropriate molten salts, and/or any other appropriate heat transfer liquid. Additionally, any appropriate gas may be employed in a . Combinations of the foregoing gases and liquids may be used together depending on the particular operating parameters.

A heat exchanger according to the present disclosure may be used in a myriad of industrial and energy applications to reduce costs and enable better heat exchange for various applications. These applications may include powerplant systems, aluminum smelting, steel production, thermal energy storage, concentrated solar power generation, compressed air energy storage, petrochemicals processing, and/or any other suitable application.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

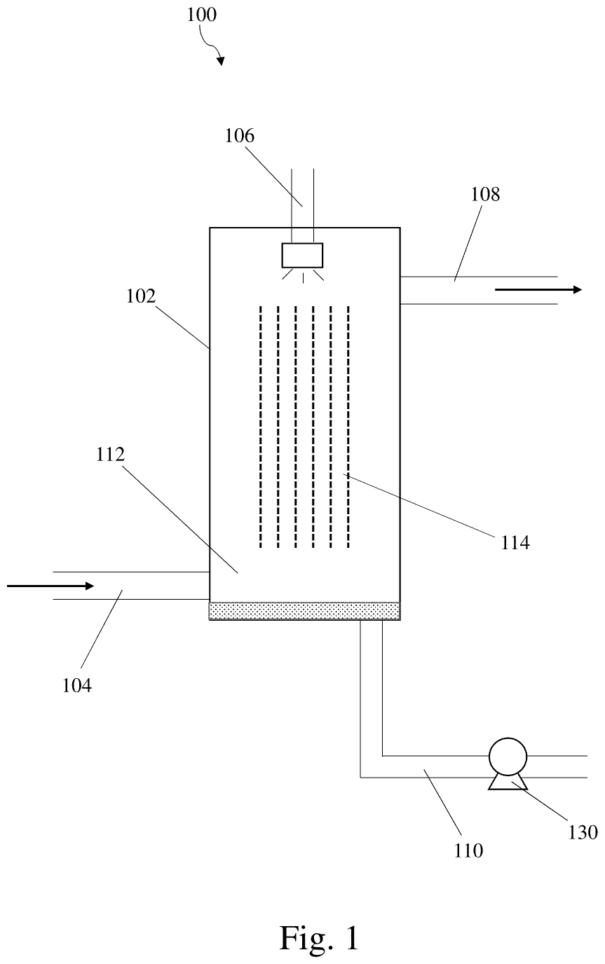

FIG. 1 is a schematic view of a heat exchanger 100 according to one illustrative embodiment. In some embodiments, the heat exchanger 100 includes a first container 102, a first gas inlet 104, a first liquid inlet 106, a first gas outlet 108, and a first liquid outlet 110. The first gas inlet 104 may be configured to supply a first gas 112 at a first temperature to the first container 102, and the first liquid inlet 106 may be configured to form a plurality of droplets of a first liquid 114 at a second temperature that flow into the interior volume of the first container 102. In some embodiments, the containers disclosed herein may be sealed to isolate the interior volume of the container relative to an exterior environment surrounding the container. In either case, gravity may cause the liquid droplets 114 to travel downwards through the first container 102 relative to a direction of gravity, while the first gas 112 travels upwards through the container 102 relative to the direction of gravity. As the first liquid 114 travels downwards and the first gas 112 travels upwards, the first liquid 114 and the first gas 112 come into direct contact with one another and exchange heat. After the first liquid 114 and the first gas 112 exchange heat, the first gas 112 then flows out of the first container 102 through the first gas outlet 108 at a temperature between the first and second temperatures and the first liquid 114 pools in a lower portion of the container relative to the direction of gravity prior to flowing out of the first container 102 through a first liquid outlet 110 at another temperature between the first and second temperatures. In some instances, the first liquid outlet may be connected to a pump 130 to facilitate transport of the first liquid out of the container. Depending on the embodiment, the pump may be configured to recirculate the collected liquid to the first liquid inlet after the liquid has been returned to the desired operating temperature through any appropriate process. Alternatively, the pump may be configured to pump the liquid to a separate heat exchanger and/or to a waste outlet. The relative temperatures of the first gas and first liquid leaving the heat exchanger may be dependent upon various parameters such as the volumetric flow rates of the fluids, the surface area of the droplets within the container, the relative velocity of the gas and droplets within the container, and/or any number of other appropriate parameters.

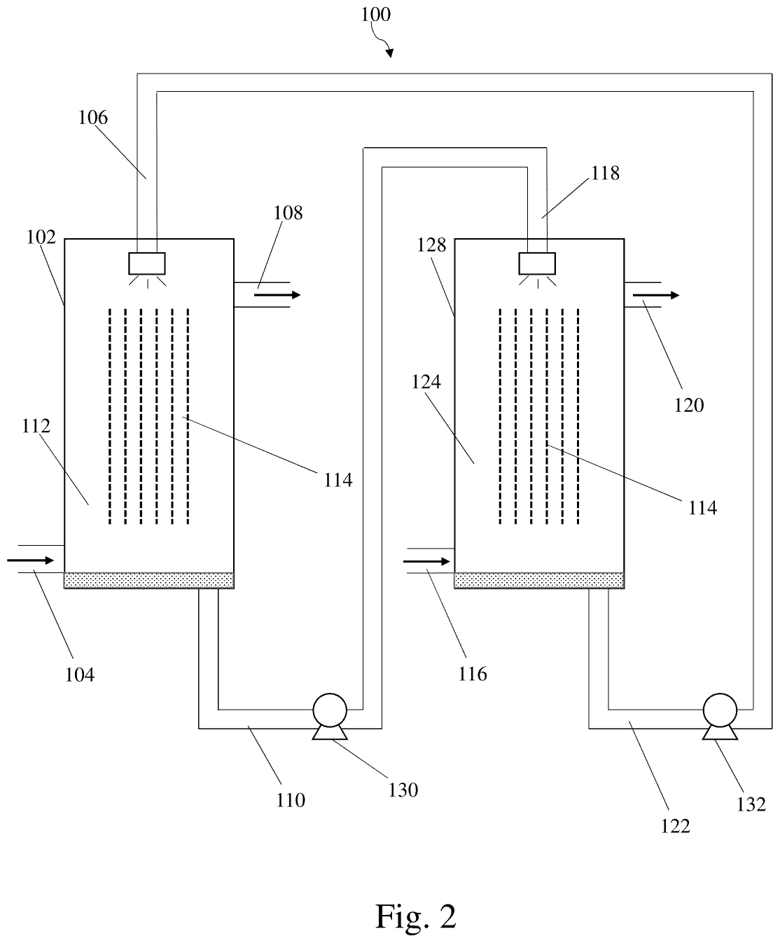

FIG. 2 is a schematic view of the heat exchanger 100 where the same liquid is used to exchange heat between two separate flows of gas in a closed loop arrangement according to a second illustrative embodiment. In some embodiments, the heat exchanger 100 may include a first container similar to that described herein and a second container 128. The second container 128 may include a second gas inlet 116 and a second liquid inlet 118. The first liquid outlet 110 of the first container 102 may connect to the second liquid inlet 118 so as to flow the first liquid 114 from the first container 102 into the second container 128. In turn, the second gas inlet 116 may supply a second gas 124 at a third temperature to the second container 128. The first liquid 114 and the second gas 124 may then exchange heat in the second container 128 through direct contact, as with the first container 102. After exchanging heat with the first liquid 114, the second gas 116 may then leave the second container 128 through a second gas outlet 120. After exchanging heat with the second gas 124, the first liquid 114 may pool in the bottom of the second container prior to flowing out from the second container 128 through a second liquid outlet 122, which may be connected to a pump in some embodiments. The second liquid outlet 122 may then flow the first liquid 114 towards the first liquid inlet 106 of the first container 102.

As discussed herein, a heat exchanger 100 may include one or more pumps 130, 132. The pumps 130, 132 may serve to control the flow of the liquid or liquids within the heat exchanger 100. For example, as shown in FIG. 2, a first pump 130 may serve to flow the first liquid 114 from the first liquid outlet 110 to the second liquid inlet 118. Correspondingly, a second pump 132 may serve to flow the first liquid 114 from the second outlet 122 to the first liquid inlet 106. Thus, the pumps 130, 132 may serve to facilitate flow through a heat exchanger 100.

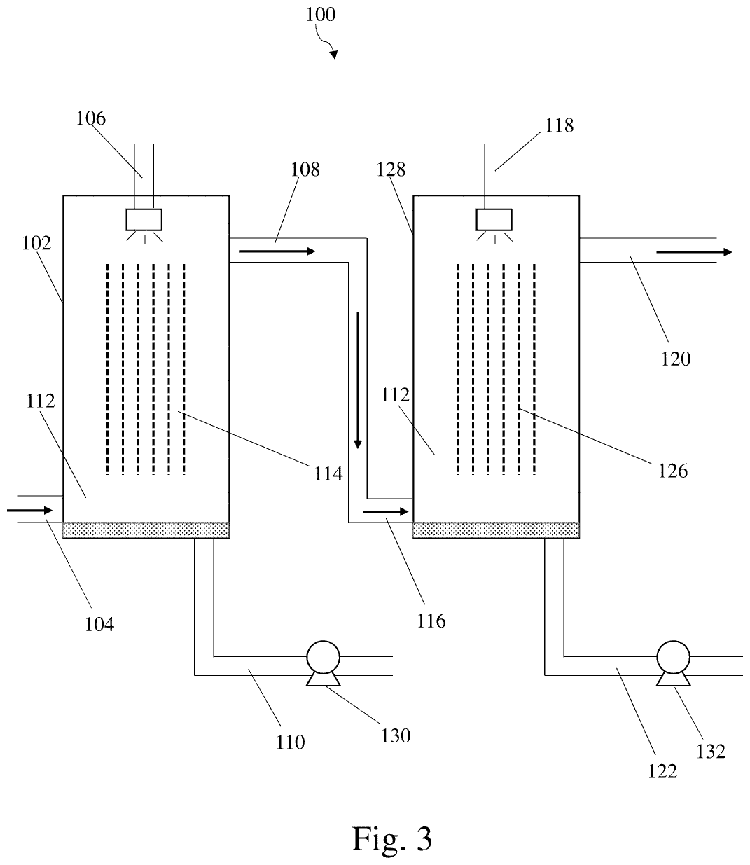

FIG. 3 is a schematic view of a heat exchanger according to a third illustrative embodiment where a single flow of gas is sequentially exposed to two or more separate liquids, which may enable a gas to go through multiple changes in temperature during a heat exchange process over a temperature range, which may be larger than a single heat exchange liquid may be capable of providing. In some embodiments, a heat exchanger 100 may include a first container similar to that described above and a second container 128 with a second gas inlet 116 and a second liquid inlet 118, wherein a first gas outlet 108 of a first container 102 flows a first gas 112 into the second gas inlet 116 of the second container 128 (e.g., after the first gas 112 exchanges heat with a first liquid 114 as described herein). In some embodiments, the first liquid may be a different heat exchange liquid than the second liquid such that the first and second liquids may have different operational temperature ranges that are at least partially non-overlapping. However, embodiments in which the first and second liquids are the same, but are simply operated at different temperatures, are also contemplated. In either case, the second liquid inlet 118 may be configured to form droplets of a second liquid 126, which may travel downwards through the second container 128 due to gravity, at a third temperature. The second liquid 126 may exchange heat with the first gas 112 through direct contact in the second container 128. After the first gas 112 and the second liquid 126 exchange heat in the second container 128, the first gas 112 may leave the second container 128 through a second gas outlet 120, while the second liquid 126 may pool in the bottom of the second container prior to flowing out of the second container 128 through the second liquid outlet 122, which may be fluidly connected to a pump in some embodiments.

In some embodiments, the first and second liquid inlets 106, 118 may include a large array of orifices for creating droplets of the liquid, similar to a shower head. Thus, the first and second liquids 114, 126 may be pumped through the orifices in the first and second liquid inlets 106, 118 to make a large array of droplets that fall downward due to gravity. However, it should be understood that any appropriate construction capable of forming droplets within an internal volume of the container including, for example, spray nozzles, one or more rotating disks the liquid is applied to, dripping through a manifold, and/or vibration-based drop formation to name a few, as the disclosure is not limited to how the droplets are formed. The first and/or second gasses 112, 124 may then flow upward in a counterflow configuration relative to the first and/or second liquids 114, 126. Thus, heat may be transferred between the first and/or second gasses 112, 124 to the first and/or second liquids 114, 126 by convection on the outer surfaces of each droplet. In some embodiments, the droplets may provide a large surface area for convection to occur via gas-liquid direct contact. Once the droplets finish their downward trajectory, they may pool at a bottom of the first and/or second containers 102, 128. In some embodiments (such as the embodiment of FIG. 2) the first liquid 114 may be pumped to the second container 128 where the first liquid 114 is again pumped through an orifice laden top of the second liquid inlet 118, once again forming into droplets.

In some embodiments, the heat exchanger 100 may be staged to exchange heat in several different temperature windows, for example using different types of liquids. For example, in the 500-1000° C. temperature range, an oxidation resistant molten salt such as CaCl₂—NaCl may be used. In the 250-500° C. range, a NaNO₃—KNO₃ molten salt may be used. In the 25-250° C. range, a heat transfer oil may be used. Of course, heat exchanger 100 may operate at any suitable temperature, including temperatures below 25° C. and greater than 1000° C. As will be appreciated by one of skill in the art, for each temperature range, any suitable liquid may be used.

As described herein, in some embodiments, a heat exchanger 100 may enable a gas to go through multiple changes in temperature during a heat exchange process over a temperature range, which may be larger than a single heat exchange liquid may be capable of providing, for example, as shown in FIG. 3. Particularly, in some embodiments, it may be desirable to cool a first gas 112 from 1000° C. to 250° C. To achieve such cooling, a first gas may be made to enter the first container 102 at a first temperature of 1000° C. via a first gas inlet 104. The first gas may then be brought into contact with a first liquid 114 configured to cool the first gas from 1000° C. to 500° C. (e.g., an oxidation resistant molten salt such as CaCl₂—NaCl). Once the first gas 112 is cooled to 500° C., the first gas 112 may exit the first container 102 via a first gas outlet 108. In turn, the first gas outlet 108 may be in series with a second gas inlet 116, which may guide the first gas 112 into a second container 128 at 500° C. In the second container 128, the first gas may be made to exchange heat through direct contact with a second liquid 126, which may be configured to cool the first gas 112 from 500° C. to 250° C. (e.g., a NaNO₃—KNO₃ molten salt). Accordingly, a heat exchanger 100 may include two containers 102, 128 to cool a first gas in multiple stages.

Though described herein as having two containers 102, 128, it should be appreciated that a heat exchanger may include any suitable number of containers. Particularly, as the value of an overall target temperature change for a gas and/or liquid increases, it may be desirable to employ more than two containers and/or liquids using any of the heat exchanger configurations described herein. For example, in some embodiments, a heat exchanger 100 may include three, four, or five or more containers to allow a temperature of a first gas to change to a greater degree and/or more gradually. It should also be appreciated that any suitable number of liquids and/or combinations of liquids may be employed, depending on the application. For example, in some instances, each container of a heat exchanger 100 may include a different liquid for exchanging heat with the first gas, though this need not be the case, as embodiments including the same liquid in multiple containers is also contemplated. In either case, the heat exchanger may take on any suitable configuration of containers, gasses, and/or liquids depending on the application, as the disclosure is not so limited in this regard.

In some embodiments, the first and second containers 102, 128 may include a pressure relief passage, which may include a pressure relief valve or other appropriate structure, on the inner portion of first and second containers 102, 128. The pressure relief passage may be configured to allow for high pressure gasses to be selectively released under one or more predetermined conditions. As the first or second gas 112, 124 heat up, their pressure may also increase. Including a relief passage on the first and second containers 102, 128 would reduce the strain on the first and second containers 102, 128 as the first and/or second gasses 112, 124 heat up, as excess pressure may be vented through the relief passage. Furthermore, the pressure relief passage may include a pressure recuperation turbine. Thus, as the pressure recuperation turbine is actuated, the heat exchanger 100 may recover most of the input work of heat exchanger 100, such as the work used to pump the first and/or second liquids 114, 126, depending on the application.

In some embodiments, the first and second containers 102, 128 may be made of welded steel, for example with thermal insulation. Of course, the first and second containers 102, 128 may be made of other materials such as magnesium, carbon fiber reinforced plastics, and/or any other suitable material. As will be appreciated by one of skill in the art, the operating temperature range of the heat exchanger 100 may influence the choice of material for the first and second containers 102, 128. Of course, the first and second containers 102, 128 may be formed from any suitable material, as the disclosure is not so limited in this regard.

As discussed herein, the first and second containers 102, 128 may include thermal insulation. Accordingly, in some embodiments, the first and/or second containers 102, 128 may each include a thermally insulated layer. The thermally insulated layer may be formed along a periphery of the first and/or second containers 102, 128 and may be formed of any suitable material. For example, in some embodiments, the thermally insulative layer may be formed from mineral wood, fiberglass, polystyrene, cellulose, and/or polyurethane foam. As will be appreciated of one of skill in the art, the operating temperatures of the heat transfer operations performed within the first and/or second containers 102, 128 may influence the choice of material for the thermally insulated layer. Of course, the thermally insulated layer may be formed from any suitable material, as the disclosure is not so limited in this regard.

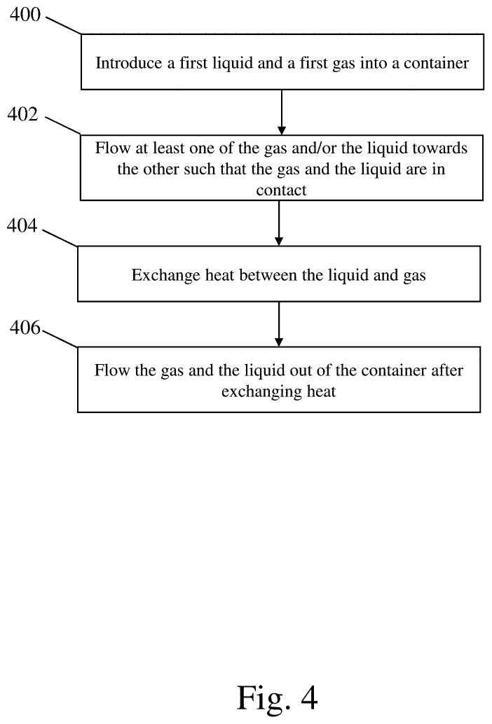

It should be appreciated that a heat exchanger according to the present disclosure may facilitate heat exchange between a liquid and a gas using any appropriate method. For example, FIG. 4 illustrates a flowchart of an exemplary method for exchanging heat between a liquid and a gas. At step 400, a liquid and a gas are introduced into a container where the liquid and gas may exchange heat (e.g., as described herein). The liquid and gas may then exchange heat via direct contact. To bring the liquid and the gas into direct contact, at step 402, at least one of the liquid and/or the gas is made to flow towards the other of the liquid and the gas such that the flow paths of the liquid and the gas are at least partially overlapping within the internal volume of the container such that the liquid and gas come into contact with one another. Additionally, in some embodiments, the separate flows of gas and liquid may be counterflows relative to each other such that the first flow path and the second flow path may be oriented at least partially in opposite directions relative to one another within at least a portion of the interior volume of a container of the heat exchanger. For example, the liquid may be made to fall vertically downwards under a force of gravity (e.g., as described herein) and the gas may be made to flow at least partially in vertical upwards direction opposite to the direction of gravity. However, embodiments in which the flows of gas and liquid are oriented in non-opposing directions and/or are oriented in the same direction relative to one another are also contemplated as the disclosure is not limited in this fashion. Regardless, once the liquid and the gas are in contact, at step 404, the liquid and the gas may exchange heat with one another, for example through convection. Once the liquid and the gas have completed exchanging heat with one another, at step 406, each of the liquid and the gas may be made to flow out of the container.

Various aspects of the present disclosure may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

The embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A heat exchanger comprising:
a first container;
a first gas inlet configured to supply a first gas at a first temperature to the first container;
a first liquid inlet configured to introduce droplets of a first liquid at a second temperature into the first container, wherein the first gas and the first liquid exchange heat in the first container through direct contact;
a first gas outlet configured such that the first gas exits the container through the first gas outlet after exchanging heat with the first liquid;
a first liquid outlet configured such that the first liquid exits the container through the first liquid outlet after exchanging heat with the first gas.

2. The heat exchanger of claim 1, wherein the droplets travel downwards through at least a portion of the first container due to gravity, and wherein the first gas flows vertically upward through at least a portion of the first container relative to gravity.

3. The heat exchanger of claim 1, further comprising a second container having a second gas inlet and a second liquid inlet, wherein the first liquid outlet is in fluid communication with the second liquid inlet.

4. The heat exchanger of claim 3, further comprising a second liquid outlet, wherein the second liquid outlet is in fluid communication with the first liquid inlet.

5. The heat exchanger of claim 4, wherein the second container includes a second gas inlet configured to supply a second gas at a third temperature to the second container.

6. The heat exchanger of claim 5, wherein the second container includes a second gas outlet configured such that the second gas exits the container through the second gas outlet after exchanging heat with the first liquid.

7. The heat exchanger of claim 6, wherein the second liquid inlet is configured to introduce droplets of the first liquid at a third temperature into the second container, wherein the droplets travel downwards through the second container due to gravity, and wherein the second gas and the first liquid exchange heat in the second container through direct contact.

8. The heat exchanger of claim 1, further comprising a second container having a second liquid inlet and a second gas inlet, wherein the first gas outlet is in fluid communication with the second gas inlet of the second container and the second liquid inlet is configured to introduce droplets of a second liquid at a third temperature into the second container, wherein the droplets of the second liquid travel downwards through the second container due to gravity, wherein the first gas and the second liquid exchange heat in the second container.

9. The heat exchanger of claim 8, wherein the second liquid and the first gas exchange heat in the second container by direct contact.

10. The heat exchanger of claim 1, wherein the first liquid inlet is a head having an array of orifices configured to form the first liquid into droplets.

11. The heat exchanger of claim 1, further comprising a pump in fluid communication with the first liquid inlet and/or the first liquid outlet.

12. The heat exchanger of claim 1, wherein the first liquid is at least one of a molten salt and a heat transfer oil.

13. A method of exchanging heat between one or more liquids and one or more gasses comprising:
flowing a first gas into a first container at a first temperature;
introducing droplets of a first liquid into the first container at a second temperature;
flowing the first gas and the droplets through an internal volume of the container;
exchanging heat between the first gas and the first liquid through direct contact between the first gas and the first liquid; and
flowing the first gas and the first liquid out of the first container after exchanging heat.

14. The method of claim 13, wherein the first gas flows vertically upward relative to a direction of gravity through at least a portion of the container and the droplets flow vertically downward through the at least a portion of the container relative to a direction of gravity

15. The method of claim 13, including flowing the first liquid into a second container and exchanging heat between the first liquid and a second gas at a third temperature.

16. The method of claim 13, including flowing the first gas into a second container and exchanging heat between the first gas and a second liquid at a third temperature.

17. The method of claim 13, including:
flowing a second gas into a second container at a third temperature;
introducing droplets of the first liquid into the second container at a fourth temperature;
flowing the second gas vertically upward through the second container and the droplets of the first liquid vertically downward through the second container relative to a direction of gravity;
exchanging heat between the second gas and the first liquid through direct contact between the second gas and the first liquid;
flowing the second gas and the first liquid out of the first container after exchanging heat.

18. The method of claim 17, including reintroducing droplets of the first liquid into the first container.

19. The method of claim 13, including:
flowing the first gas into a second container at a third temperature;
introducing droplets of a second liquid into the second container at a fourth temperature;
flowing the first gas vertically upward through the second container and the droplets of the second liquid vertically downward through the second container relative to a direction of gravity;
exchanging heat between the first gas and the second liquid through direct contact between the second gas and the first liquid;
flowing the second gas and the first liquid out of the first container after exchanging heat.

20. The method of claim 13, wherein introducing droplets of a first liquid into the first container at a second temperature includes pumping the second liquid at a flow rate based at least in part on desired relative temperatures of the first gas and the first liquid.
